(19) United States
(12) Patent Application Publication
(10) Pub. No.: US 2012/0263413 A1
(43) Pub. Date: Oct. 18, 2012

(54) WAVEGUIDE TYPE HIGH DENSITY OPTICAL MATRIX SWITCHES

(75) Inventors: Jang Uk SHIN, Daejeon (KR); Young-Tak Han, Daejeon (KR); Sang Ho Park, Daejeon (KR); Yongsoon Baek, Daejeon (KR)

(73) Assignee: ELECTRONICS AND TELECOMMUNICATIONS RESEARCH INSTITUTE, Daejeon (KR)

(21) Appl. No.: 13/347,719

(22) Filed: Jan. 11, 2012

(30) Foreign Application Priority Data
Apr. 13, 2011 (KR) 10-2011-0034261

(51) Int. Cl. G02B 6/26

(52) U.S. Cl. 385/17

(57) ABSTRACT

An optical matrix switch includes connection optical waveguides, a 2×2 optical switch including two straight optical waveguides which are parallel to each other, two crossing optical waveguides which connects the insides of the straight optical waveguides and mutually intersects in an X shape, and electrodes which are disposed on portions where the straight optical waveguide and the crossing optical waveguide are connected. The connection optical waveguides include a straight connection optical waveguide which connects one of the straight optical waveguides of one of the 2×2 optical switches in one column and a straight optical waveguide of a 2×2 optical switch in the same row of an adjacent column, and a crossing connection optical waveguide which connects the other of the straight optical waveguides with a straight optical waveguide of 2×2 optical switch in the other row of an adjacent column

### CROSS-REFERENCE TO RELATED APPLICATIONS

This U.S. non-provisional patent application claims priority under 35 U.S.C. §119 of Korean Patent Application No. 10-2011-0034261, filed on Apr. 13, 2011, the entire contents of which are hereby incorporated by reference.

### BACKGROUND OF THE INVENTION

The present invention disclosed herein relates to a waveguide type optical switch, and more particularly, to a high density optical matrix switch.

As internet traffic increases, efficient transfer of large scale signals between a plurality of points becomes necessary. Accordingly, a ring-shaped or mesh-shaped network is required. In a ring-shaped network, the Reconfigurable Optical Add-Drop Multiplexing (ROADM) system is usually used. In a mesh-shaped network which requires a complex switching function, Optical Cross Connector (OXC) technology is used with a wavelength unit of a Dense Wavelength Division Multiplexing (DWDM) signal. Current OXCs are classified into two types; an opaque type in which an optical-to-electric conversion—switching—electric-to-optical conversion process is performed, and a transparent type in which an optical matrix switch is used. The demand for the transparent type OXC, which can switch optical signals without the optical-to-electric or electric-to-optical conversion so as not to pass a higher layer switch, is greatly increasing with the recent rapid increase in traffic. In order to commercialize the transparent type OXC, ensuring a reliable supply of optical matrix switches is the most essential factor.

A typical representative optical matrix switch technology is an optical matrix switch using Micro Electro Mechanical Systems (MEMS) technology. This type of optical matrix switches can change an optical path by moving a mirror through electric actuation in a precisely manufactured micromechanical device to reflect optical signals. For such a type optical matrix switch, an optical system for optical collimation is required at an optical input unit and an optical output unit provided for each path. Also, a very complex manufacturing process with multiple steps is needed to manufacture micro mirrors. In addition, since such type optical matrix switches include a mechanical structure that is prone to deformation during use, they are fundamentally unstable due to variables in the surrounding environment such as dust, vibration, and fluctuations in temperature.

### SUMMARY OF THE INVENTION

The present invention provides a high density optical matrix switch which has a very simple structure with no mechanical moving part, thereby having excellent stability.

The object of the present invention is not limited to the aforesaid, but other objects not described herein will be clearly understood by those skilled in the art from descriptions below.

Embodiments of the present invention providing an n×n optical matrix switch (where n is 2^{x}; x is natural number of 2 or more) plurality of 2×2 optical switches comprising: two straight optical waveguides which are parallel to each other; two crossing optical waveguides which connect the insides of the straight optical waveguides and mutually intersect in an X shape between the straight optical waveguides; and a plurality of electrodes which are respectively disposed on a plurality of portions where the straight optical waveguides and the crossing optical waveguides are connected. Embodiments of the present invention also includes a plurality of connection optical waveguides comprising: the straight optical waveguides which connect the optical waveguides of the 2×2 optical switches array in one column and the optical waveguide of another 2×2 optical switches array in the same row of an adjacent column; and crossing optical waveguides which connect the other optical waveguides to the waveguides of the other row of the adjacent column

In some embodiments, the straight optical waveguides, the crossing optical waveguides and the connection optical waveguides may be multi-mode optical waveguide.

In other embodiments, the straight optical waveguides and the crossing optical waveguides may perform total internal reflection when the electrode is in an operation state.

In still other embodiments, each of the waveguides may have a negative thermo-optic coefficient.

In even other embodiments, the bent angle of the crossing optical waveguide with respect to the straight optical waveguide may be in a range of about 6 degrees to about 12 degrees.

In yet other embodiments, the optical waveguide structure may include a substrate, a lower-clad on the substrate, a core on the lower-clad, and an upper-clad on the core.

In still further embodiments, the substrate may include a silicon material or a glass material.

In even further embodiments, the lower-clad, the core, and the upper-clad may be a polymer.

In yet further embodiments, a refractive index difference between the core and the lower-clad and a refractive index difference between the core and the upper-clad may be in a range of about 0.25%−Δ to about 1%−Δ.

In much further embodiments, the straight optical waveguides and the crossing optical waveguides may have a width in a range of about 20 μm to about 50 μm.

In even much further embodiments, a bent angle of the crossing connection optical waveguide with respect to the straight optical waveguide of 2×2 optical switches may be in a range of about 4 degrees to about 30 degrees.

In yet much further embodiments, the optical matrix switch may further include a plurality of trenches formed close to portions where the crossing connection optical waveguides are bent and change a direction of light.

In still much further embodiments, the trench may have a depth greater than a thickness of the upper-clad and less than a total sum of thicknesses of the lower-clad, the core, and the upper-clad.

In even much further embodiments, the optical matrix switch may further include an optical material filling trenches, of which the refraction index may be less than the core.

In yet much further embodiments, the connection optical waveguides may have a width equal to or greater than the straight optical waveguides and the crossing optical waveguides.

In still much further embodiments, electrodes in a 2×2 optical switch may operate all at once.

In even much further embodiments, the optical matrix switch may further include a front end 2×2 optical switch array connected by the connection optical waveguides with the straight optical waveguides of the 2×2 optical switches in start column, and including a plurality of 2×2 optical switches equal to the number of rows; and a rear end 2×2 optical switch array which is connected by the connection optical waveguides with the straight optical waveguides of the 2×2 optical switches in an end column, and including a plurality of 2×2 optical switches equal to the number of rows.

In yet much further embodiments, the optical matrix switch may further include input ports which are connected to start portions of the straight optical waveguides of the front end 2×2 optical switch array and connected to optical fibers for the input; and output ports which are connected to end portions of the straight optical waveguides of the rear end 2×2 optical switch array and connected to optical fibers for the output.

In still much further embodiments, each of the input ports and output ports may include a taper-shaped optical waveguide connected to the straight optical waveguide; and a single-mode optical waveguide connected to the taper-shaped optical waveguide.

In other embodiments of the present invention, an n×n high density optical matrix switch (where n is 2^{x}; x is natural number of 2 or more) includes a 2×2 optical switch including: two straight optical waveguides which are parallel to each other; two crossing optical waveguides which connect the insides of the straight optical waveguides and mutually intersect in an X shape, between the straight optical waveguides; and a plurality of electrodes which are respectively disposed on a plurality of portions where the straight optical waveguides and the crossing optical waveguides are connected; a plurality of connection optical waveguides including: a straight connection optical waveguide which connects one of the straight optical waveguides of one of the 2×2 optical switches in one column and a straight optical waveguide of a 2×2 optical switch in the same row of an adjacent column; and a crossing connection optical waveguide which connects the other of the straight optical waveguides and a straight optical waveguide of a 2×2 optical switch in the other row of an adjacent column; and a plurality of trenches formed close to portions where the connection optical waveguide are bent, respectively, and changes a path of light.

In some embodiments, the straight optical waveguides, the crossing optical waveguides and the connection optical waveguides may be multi-mode optical waveguide.

In other embodiments, the straight optical waveguides, the crossing optical waveguides and the connection optical waveguides may be polymer multi-mode optical waveguide.

In still other embodiments, the optical matrix switch may further include a front end 2×2 optical switch array connected by the connection optical waveguides and straight optical waveguides of the 2×2 optical switches in start column, and including a plurality of 2×2 optical switches equal to the number of rows; and a rear end 2×2 optical switch array which is connected by the connection optical waveguides and straight optical waveguides of the 2×2 optical switches in an end column, and including a plurality of 2×2 optical switches equal to the number of rows.

In even other embodiments, the optical matrix switch may further include input ports which are connected to start portions of the straight optical waveguides of the front end 2×2 optical switch array and connected to optical fibers for the input; and output ports which are connected to end portions of the straight optical waveguides of the rear end 2×2 optical switch array and connected to optical fibers for the output.

In yet other embodiments, each of the input ports and the output ports may include a taper-shaped optical waveguide connected to the straight optical waveguide; and a single-mode optical waveguide connected to the taper-shaped optical waveguide.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a plan view illustrating a structure of a 2×2 optical switch which is used as a basic unit of an n×n optical matrix switch according to an embodiment of the present invention;

FIG. 2 is a plan view illustrating a structure of a 4×4 optical matrix switch according to an embodiment of the present invention;

FIG. 3 is a plan view illustrating a structure of an 8×8 optical matrix switch according to an embodiment of the present invention;

FIG. 4 is a schematic view illustrating a structure of an n×n optical matrix switch according to an embodiment of the present invention; and

FIG. 5 is a plan view illustrating a curve structure of a bent optical waveguide which is used in an n×n optical matrix switch according to an embodiment of the present invention.

### DETAILED DESCRIPTION OF PREFERRED EMBODIMENTS

Embodiments of the present invention will be described below in detail with reference to the accompanying drawings. Advantages and features of the present invention, and implementation methods thereof will be clarified through following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Like reference numerals refer to like elements throughout.

In the following description, the technical terms are used only for explaining a specific exemplary embodiment while not limiting the inventive concept. The terms of a singular form may include plural forms unless referred to the contrary. The meaning of ‘comprises’ and/or ‘comprising’ specifies a property, a region, a fixed number, a step, a process, an element and/or a component but does not exclude other properties, regions, fixed numbers, steps, processes, elements and/or components. Since exemplary embodiments are provided below, the order of the reference numerals given in the description is not limited thereto. In the specification, it will be understood that when a layer (or film) is referred to as being ‘on’ another layer or substrate, it can be directly on the other layer or substrate, or intervening layers may also be present.

Additionally, the embodiment in the detailed description will be described with sectional views as ideal exemplary views of the present invention. In the figures, the dimensions of layers and regions are exaggerated for clarity of illustration. Accordingly, shapes of the exemplary views may be modified according to manufacturing techniques and/or allowable tolerances. Therefore, the embodiments of the present invention are not limited to the specific shape illustrated in the exemplary views, but may include other shapes that may be created according to manufacturing processes. For example, an etched region illustrated as a rectangle may have rounded or curved features. Areas exemplified in the drawings have general properties, and are used to illustrate a specific shape of a semiconductor package region. Thus, this should not be construed as limited to the scope of the present invention.

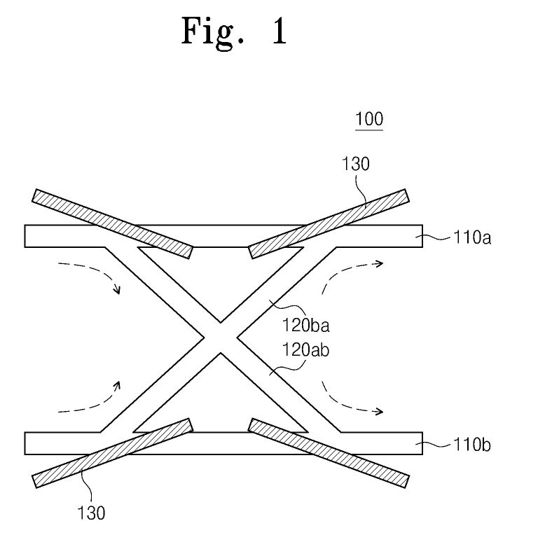

FIG. 1 is a plan view illustrating a structure of a 2×2 optical switch which is used as a basic unit of an n×n optical matrix switch according to an embodiment of the present invention.

Referring to FIG. 1, a 2×2 optical switch 100 includes two straight optical waveguides 110a and 110b, two crossing optical waveguides 120ab and 120ba, and four electrodes 130.

The two straight optical waveguides 110a and 110b are parallel to each other. The two crossing optical waveguides 120ab and 120ba may exist insides of the straight optical waveguides 110a and 110b between the straight optical waveguides 110a and 110b and mutually intersect in an X shape. A bent angle of the crossing optical waveguides 120ab and 120ba with respect to the straight optical waveguides 110a and 110b may be in the range of about 6 degrees to about 12 degrees. The four electrodes 130 may be positioned on portions where the straight optical waveguides 110a and 110b and the crossing optical waveguides 120ab and 120ba are connected. The electrodes 130 may be bent with respect to the straight optical waveguides 110a and 110b with half the bent angle of the crossing optical waveguides 120ab and 120ba with respect to the straight optical waveguide 110a and 110b.

The straight optical waveguides 110a and 110b and the crossing optical waveguides 120ab and 120ba may be multi-mode optical waveguide. The straight optical waveguides 110a and 110b and the crossing optical waveguides 120ab and 120ba may be polymer multi-mode optical waveguide. The straight optical waveguides 110a and 110b and the crossing optical waveguides 120ab and 120ba may include a substrate, a lower-clad on the substrate, a core on the lower-clad, and an upper-clad on the core. The lower-clad, the core, and the upper-clad may be a polymer. The substrate may be a material with a high thermal conductivity when the electrodes 130 are in an operation state. The substrate may include a silicon material or a glass material. The straight optical waveguides 110a and 110b and the crossing optical waveguides 120ab and 120ba may have a width in a range of about 20 μm to about 50 μm.

The electrodes 130 may perform total internal reflection using a thermo-optic effect on portions where the straight optical waveguides 110a and 110b and the crossing optical waveguides 120ab and 120ba are connected. Each of the straight optical waveguides 110a and 110b and the crossing optical waveguides 120ab and 120ba may have a negative thermo-optic coefficient. The electrodes 130 may be a heater electrode.

A difference between core-clad refractive indices of the straight optical waveguides 110a and 110b and the crossing optical waveguides 120ab and 120ba is so small that the difference may be in a range of about 0.35%−Δ to enable switching via total internal reflection in relatively low temperature difference. In this case, a mode size may be almost the same as that of a general common optical fiber, and thus an optical fiber coupling loss may be also extremely low.

In the 2×2 optical switch 100, when the electrodes 130 are not operated, a light input to the two parallel straight waveguides 110a and 110b is output in a bar state through the two parallel straight waveguides 110a and 110b, but when the electrodes 130 are operated, a light input to the two parallel straight waveguides 110a and 110b is output in a cross state to the opposite two parallel straight optical waveguides 110a and 110b through X-shaped two crossing optical waveguides 120ab and 120ba by the total internal reflection caused by the variation of the refractive indices by the operations of the electrodes 130.

At this point, since the four electrodes 130 may be operated all at once, the electrodes 130 may be connected to one power source and simultaneously operated. Accordingly, for an optical matrix switch using a typical MEMS technology, electrodes of a basic switch should be controlled separately, but since the four electrodes 130 of the 2×2 optical switch 100 of the present invention can be simultaneously controlled in a bundle, the switch control circuit can be reduced in size by less than a quarter.

A high density optical matrix switch according to an embodiment of the present invention uses a 2×2 optical switch 100 as a basic structure and is configured through a multi-step connection using a multi-mode optical waveguide. A structure where the 2×2 optical switches 100 are multi-step connected for a high density optical matrix switch will be described below.

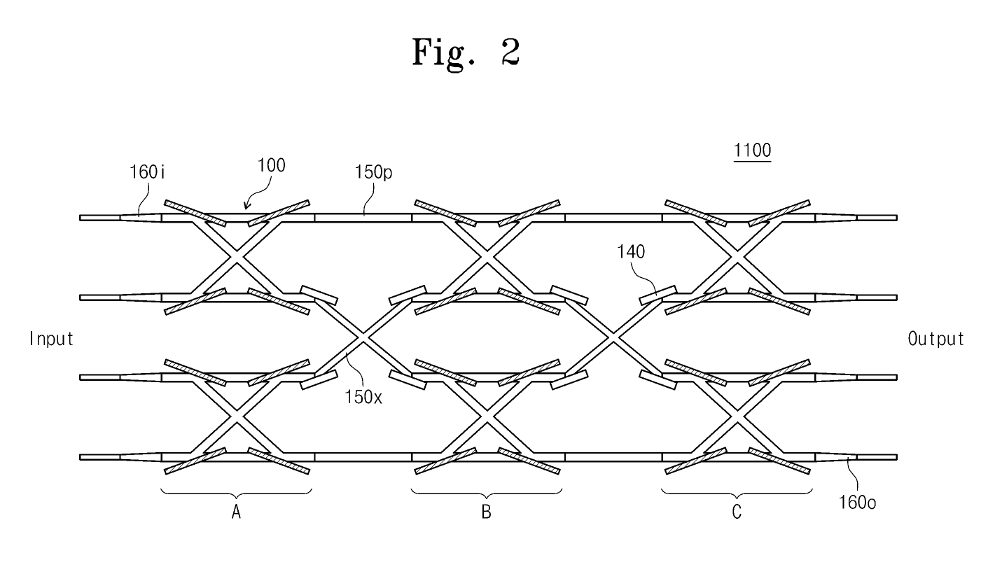

FIG. 2 is a plan view illustrating a structure of a 4×4 optical matrix switch according to an embodiment of the present invention.

Referring to FIG. 2, a 4×4 optical matrix switch 1100 may be configured by connecting a switching unit B which includes upper and lower 2×2 optical switches (see 100 of FIG. 1), and a front end 2×2 optical switch array A and a rear end 2×2 optical switch array C which are disposed at the front end and rear end of the switching unit B, respectively, using connection optical waveguides 150p and 150x. The number of the 2×2 optical switches in the front end and rear end 2×2 optical switch arrays A and C may be the same as the number of rows of the switching unit B. That is, the front end and rear end 2×2 optical switch arrays A and C may be configured with two 2×2 optical switches into the 4×4 optical matrix switch 1100.

One of straight optical waveguides (See 110a and 110b of FIG. 1) of each of two 2×2 optical switches in the front end 2×2 optical switch array A may be connected to a straight optical waveguide of the upper 2×2 optical switch of the switching unit B, and the other may be connected to a straight optical waveguide of the lower 2×2 optical switch of the switching unit B. One of straight optical waveguides of each of two 2×2 optical switches in the rear end 2×2 optical switch array C may be connected to a straight optical waveguide of the upper 2×2 optical switch of the switching unit B, and the other may be connected to a straight optical waveguide of the lower 2×2 optical switch of the switching unit B.

The connection optical waveguides may include a straight connection optical waveguide 150p connecting one of straight optical waveguides of one of the 2×2 optical switches in the front end and rear end 2×2 optical switch arrays A and C to a straight optical waveguide of the 2×2 optical switch in the same row of the switching unit B, and a crossing connection optical waveguide 150x connecting the other of straight optical waveguides of one of the 2×2 optical switches in the front end and rear end 2×2 optical switch arrays A and C to a straight optical waveguide of the 2×2 optical switch in another row of the switching unit B. A bent angle of the crossing connection optical waveguides 150x with respect to the straight optical waveguides may be in a range of about 4 degrees to about 30 degrees.

The connection optical waveguides 150p and 150x may be multi-mode optical waveguide. The connection optical waveguides 150p and 150x may be a polymer multi-mode optical waveguide. The connection optical waveguides 150p and 150x may have a width equal to or greater than the straight optical waveguides and the crossing optical waveguides (See 120ab and 120ba of FIG. 1). The connection optical waveguides 150p and 150x may have a width in a range of about 20 μm to about 60 μm.

Trenches 140 may be included, which are formed close to the portions where the crossing connection optical waveguides 150x are bent and change a direction of light path. The trenches 140 may be formed to be disposed in a bent shape to the straight light with half the bent angle of the crossing connection optical waveguides 150x with respect to straight optical waveguides. The trench 140 may have a depth greater than a thickness of the upper-clad and less than the sum of thicknesses of the lower-clad, the core, and the upper-clad.

An optical material may be further included, which fills the trenches 140. The optical material may have a refractive index less than the core.

The 4×4 optical matrix switch 1100 may further include input ports 160i which are connected to start portions of the straight optical waveguides of the 2×2 optical switches of the front end 2×2 optical switch array A and connected to optical fibers for the input (not shown) and output ports 160o which are connected to end portions of the straight optical waveguides of the 2×2 optical switches of the rear end 2×2 optical switch array C and connected to optical fibers for the output (not shown). The input ports 160i and output ports 160o may each include a taper-shaped waveguide which are connected to straight optical waveguides of the 2×2 optical switches of the front end and rear end 2×2 optical switch arrays A and C and a single-mode optical waveguide which is connected to the taper-shaped waveguide.

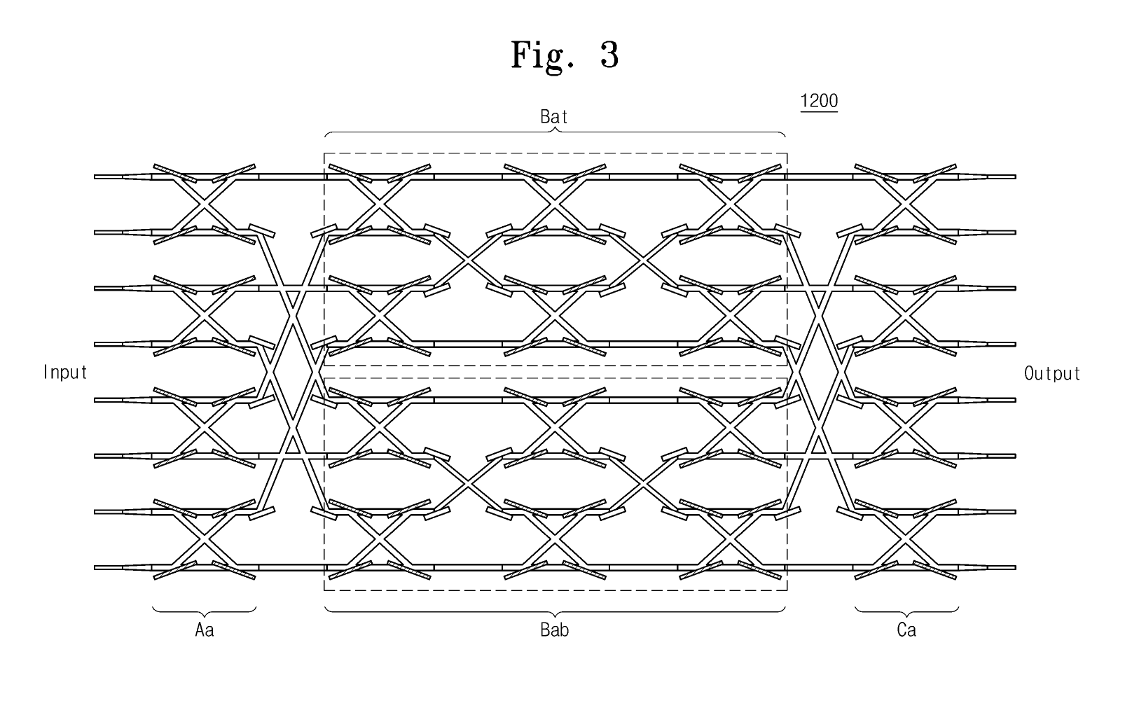

FIG. 3 is a plan view illustrating a structure of an 8×8 optical matrix switch according to an embodiment of the present invention.

Referring to FIG. 3, an 8×8 optical matrix switch 1200 may be configured by connecting a switching unit Bab and Bat, which includes upper and lower 4×4 optical matrix switches (see 1100 of FIG. 2), and a front end 2×2 optical switch array Aa and a rear end 2×2 optical switch array Cc which are disposed at the front end and the rear end of the switching unit B, respectively, using the connection optical waveguides (See 150p and 150x of FIG. 2). The number of 2×2 optical switches in the front end and rear end 2×2 optical switch arrays Aa and Ca may be the same as the number of rows of the switching unit Bab and Bat. That is, the front end and rear end 2×2 optical switch arrays Aa and Ca may be configured with four 2×2 optical switches into the 8×8 optical matrix switch 1200.

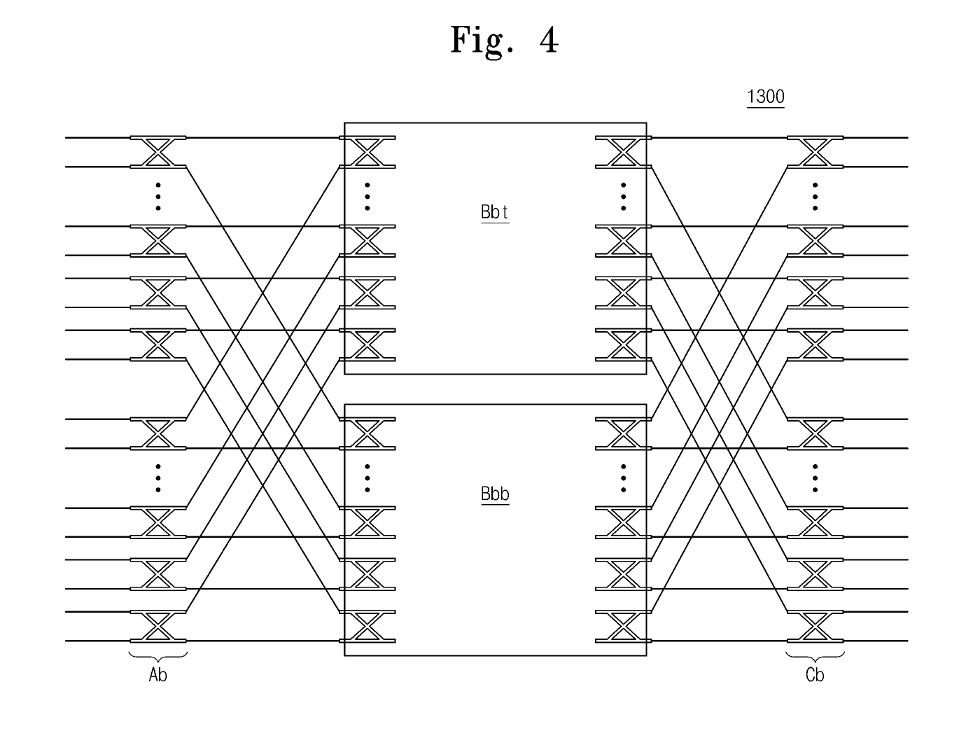

FIG. 4 is a schematic view illustrating a structure of an n×n optical matrix switch according to an embodiment of the present invention.

Referring to FIG. 4, an n×n (where n=2^{x}; x is natural number, which is two or more) optical matrix switch 1300 may be configured by connecting a switching unit Bbb and Bbt, which includes upper and lower (n/2)×(n/2) optical matrix switches, and a front end 2×2 optical switch array Ab and a rear end 2×2 optical switch array Cb which are disposed at the front end and the rear end of the switching unit Bbb and Bbt, respectively, using the connection optical waveguides (See 150p and 150x of FIG. 2). The number of 2×2 optical switches in the front end and rear end 2×2 optical switch arrays Ab and Cb may be the same as the number of rows of the switching unit Bbb and Bbt. That is, the front end and rear end 2×2 optical switch arrays Ab and Cb may be configured with an n/2 number of 2×2 optical switches in the n×n optical matrix switch 1300.

To this end, n×n optical matrix switch 1300 may be configured by connecting only 2×2 optical switches, where n is 2^{x}. In the present invention, a connection optical waveguide for connecting 2×2 optical switches may be configured with a multi-mode optical waveguide which is the same as that of a 2×2 optical switch, thereby removing an adiabatic taper structure for conversion between a single-mode optical waveguide and a multi-mode optical waveguide. Accordingly, a high density n×n optical matrix switch 1300 can be configured simply and easily.

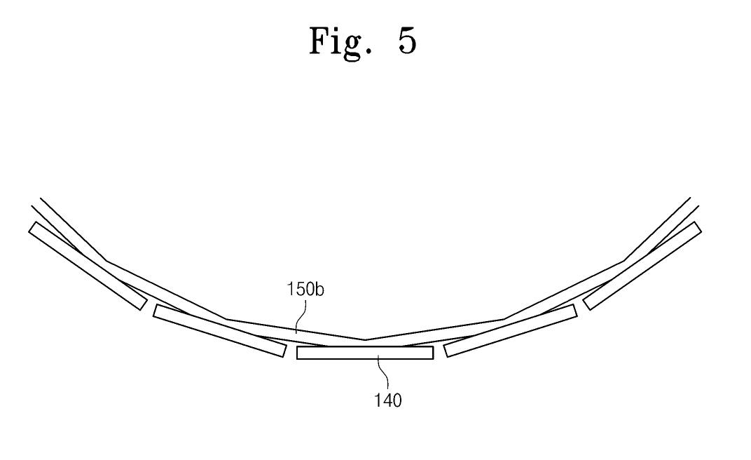

FIG. 5 is a plan view illustrating a curved line structure of a bent optical waveguide which is used in an n×n optical matrix switch according to an embodiment of the present invention.

Referring to FIG. 5, in order to configure an optical matrix switch such as embodiments of FIGS. 2 through 4 by connecting only 2×2 optical switches, a bend of a multi-mode optical waveguide such as a crossing connection optical waveguide (150x of FIG. 2) is needed.

Generally, a radius of curvature is directly related to an optical loss, which is need in a bend of an optical waveguide. To reduce the optical loss, a curved line with a great radius of curvature should be used. For the curved line with a great radius of curvature, however, the size of an entire optical device cannot but increase with an increase in the size of the curved line. Accordingly, a high density optical device cannot be manufactured. Accordingly, in the present invention, a trench structure which includes trenches 140 may perform total reflection in a bent multi-mode optical waveguide 150b is applied such that the radius of curvature of a multi-mode optical waveguide is effectively reduced to manufacture a high density n×n optical matrix switch.

The bent multi-mode optical waveguide 150b has a structure where bends with a small angle of a straight multi-mode optical waveguide are connected, and in the bent portion between straight multi-mode optical waveguides, the trenches 140 are formed by etching a specific area for total reflection of a light. A light input to the bent multi-mode optical waveguide 150b is totally reflected in the area where the trenches 140 are formed, an optical signal is transmitted through the bends of the bent multi-mode optical waveguide 150b. Since the bend is sequentially repeated several times, the bend of a multi-mode optical waveguide can be obtained as needed. At this point, considering the penetration depth of an electromagnetic field in the total reflection, the position of a reflective surface of the trench 140 is needed to be adjusted shallowly by about 1 μm.

As a result that a loss due to an optical transmission in the bent multi-mode optical waveguide 150b with the trenches 140 is calculated in a beam propagation method (BPM), when the bent multi-mode optical waveguide 150b has a width of about 45 μm and a bent angle of about 20 degrees, a loss of about 0.08 dB is shown in one time bending. Thus, when two times bending is used to obtain the bend of about 40 degrees, a low loss of about 0.16 dB may be predicted. In this case, the bent multi-mode optical waveguide 150b has a very small radius of the curvature of about 1,500 μm or less.

The n×n optical matrix switch according to embodiments of the present invention may be configured by connecting only the 2×2 optical switches, and thus can have a very simple structure with no mechanical movement. Accordingly, a high density optical matrix switch with good stability can be provided.

Moreover, the n×n optical matrix switch according to embodiments of the present invention has a very simple structure and process, compared to an optical matrix switch using a typical MEMS technology, and thus has a very advantageous structure for manufacturing the high density optical matrix switch at low cost.

And also, the n×n optical matrix switch according to embodiments of the present invention has a structure with no mechanical movement, compared to the optical matrix switch using the typical MEMS technology, and thus has a good structure that is very stable to the environmental change factors such as mechanical vibration or temperature variation.

Moreover, the n×n optical matrix switch according to embodiments of the present invention may simultaneously control the four electrodes of the 2×2 optical switch being a basic unit in a bundle, and thus have a control circuit configuration simpler than the typical optical matrix switch.

Furthermore, the n×n optical matrix switch according to embodiments of the present invention may apply a single-mode optical waveguide and a taper shaped optical waveguide to only optical input/output parts and use a multi-mode optical waveguide in cross portions where other optical waveguides cross in series and/or parallel, and thus the size of the optical matrix switch can be significantly reduced. For example, the typical 16×16 optical matrix switch using the silica optical waveguide has the refractive index difference between a core and a clad that is 0.75%−Δ and uses an optical waveguide with the refractive index difference greater than that of the present invention, but the 16×16 optical matrix switch chip has a width and length of 10 cm or more. On the other hand, a total reflection type 16×16 optical matrix switch chip using the multi-mode optical waveguide, according to embodiments of the present invention, can be manufactured to within about 5.5 cm in width and length. Accordingly, optical modules can be easily mass-produced at low cost.

In addition, the n×n optical matrix switch according to embodiments of the present invention may use a polymer optical waveguide which has the very high absolute value of the thermo-optical coefficient and has low consumption power when using the total internal reflection effect, and moreover, use an optical waveguide structure where the refractive index difference between a core and a clad is low. Accordingly, the total refraction efficiency can be maximized, and thus, the n×n optical matrix switch has a significant advantage in consumption power. For example, the typical optical matrix switch using the silica optical waveguide has consumption power of 300-600 mW for each electrode, but in embodiments of the present invention, consumption power is about 20-25 mW for each electrode.

As described above, the n×n optical matrix switch according to embodiments of the present invention has low optical loss, good isolation, small chip size, and low powered operability, and ultimately facilitates the enhancement of production yield, low cost, and mass production.

The above-disclosed subject matter is to be considered illustrative and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description. Thus, the above-disclosed embodiments are to be considered illustrative, and not restrictive.

1. An optical matrix switch comprising:
a 2×2 optical switch comprising: two straight optical waveguides which are parallel to each other; two crossing optical waveguides which connect the insides of the straight optical waveguides and mutually intersect in an X shape, between the straight optical waveguides; and a plurality of electrodes which are respectively disposed on a plurality of portions where the straight optical waveguides and the crossing optical waveguides are connected; and
a plurality of connection optical waveguides comprising: a straight connection optical waveguide which connects one of the straight optical waveguides of one of the 2×2 optical switches in one column and a straight optical waveguide of a 2×2 optical switch in the same row of an adjacent column; and a crossing connection optical waveguide which connects the other of the straight optical waveguides and a straight optical waveguide of a 2×2 optical switch in the other row of an adjacent column,
wherein the straight optical waveguides, the crossing optical waveguides, and the connection optical waveguides are multi-mode optical waveguide.

2. The optical matrix switch of claim 1, wherein the straight optical waveguides and the crossing optical waveguides perform total internal reflection when the electrode is in an operation state.

3. The optical matrix switch of claim 1, wherein a bent angle of the crossing optical waveguide with respect to the straight optical waveguide is in a range of about 6 degrees to about 12 degrees.

4. The optical matrix switch of claim 1, wherein each of the straight optical waveguides, the crossing optical waveguides, and the connection optical waveguides comprises:
a substrate;
a lower-clad on the substrate;
a core on the lower-clad; and
an upper-clad on the core.

5. The optical matrix switch of claim 4, wherein a refractive index difference between the core and the lower-clad and a refractive index difference between the core and the upper-clad are in a range of about 0.25%−Δ to about 1%−Δ.

6. The optical matrix switch of claim 1, wherein each of the straight optical waveguides and the crossing optical waveguides has a width in a range of about 20 μm to about 50 μm.

7. The optical matrix switch of claim 1, wherein a bent angle of the crossing connection optical waveguide with respect to the straight optical waveguide is in a range of about 4 degrees to about 30 degrees.

8. The optical matrix switch of claim 7, further comprising a plurality of trenches formed adjacently to a plurality of portions where the crossing connection optical waveguides are bent, respectively, and changing a direction of light.

9. The optical matrix switch of claim 8, wherein each of the trenches has a depth greater than a thickness of the upper-clad and less than a total sum of thicknesses of the lower-clad, the core, and the upper-clad.

10. The optical matrix switch of claim 1, wherein the connection optical waveguides have a width equal to or greater than the straight optical waveguides and crossing optical waveguides.

11. The optical matrix switch of claim 1, further comprising:
a front end 2×2 optical switch array connected by the connection optical waveguides with the straight optical waveguides of the 2×2 optical switches in a start column, and comprising a plurality of 2×2 optical switches equal to the number of rows; and
a rear end 2×2 optical switch array connected by the connection optical waveguides with the straight optical waveguides of the 2×2 optical switches in an end column, and comprising a plurality of 2×2 optical switches equal to the number of rows.

12. The optical matrix switch of claim 11, further comprising:
a plurality of input ports connected to start portions of the straight optical waveguides of the front end 2×2 optical switch array and connected to a plurality of optical fibers for input; and
a plurality of output ports connected to end portions of the straight optical waveguides of the rear end 2×2 optical switch array and connected to a plurality of optical fibers for output.

13. The optical matrix switch of claim 12, wherein each of the input ports and the output ports comprises:
a taper-shaped optical waveguide connected to the straight optical waveguide; and
a single-mode optical waveguide connected to the taper-shaped optical waveguide.
